(19) United States
(12) Patent Application Publication
(10) Pub. No.: US 2025/0118455 A1
(43) Pub. Date: Apr. 10, 2025

(54) ELECTROCONDUCTIVE FILM, SENSOR DEVICE, AND METHOD OF PRODUCING ELECTROCONDUCTIVE FILM

(71) Applicants: CANON KABUSHIKI KAISHA, Tokyo (JP); CANON VIRGINIA, INC., Newport News, VA (US)

(72) Inventors: YUMA KOBAYASHI, Kanagawa (JP); KEI INOUE, Kanagawa (JP); KEIGO MIZUSAWA, Tokyo (JP); WAKA HASEGAWA, Tokyo (JP)

(21) Appl. No.: 18/988,084

(22) Filed: Dec. 19, 2024

Related U.S. Application Data
(63) Continuation of application No. PCT/JP2023/022844, filed on Jun. 21, 2023.

(30) Foreign Application Priority Data
Jun. 23, 2022 (JP) 2022-101379
May 31, 2023 (JP) 2023-090082

(51) Int. Cl. H01B 5/14; H01B 1/16; H01B 13/30

(52) U.S. Cl. CPC H01B 5/14; H01B 1/16; H01B 13/30

(57) ABSTRACT

Provided are a fibroin film having an electroconductive wiring pattern with high fixability, a sensor device, and a biological sensor device. Specifically, provided is an electroconductive film including: a base material containing fibroin; and electroconductive wiring containing a plurality of electroconductive particles, wherein the electroconductive wiring includes: a permeation portion formed of the electroconductive particles in a permeation layer in which the electroconductive particles have permeated the base material; and a non-permeation portion formed of the electroconductive particles prevented from permeating the base material.

### CROSS-REFERENCE TO RELATED APPLICATIONS

This application is a Continuation of International Patent Application No. PCT/JP2023/022844, filed Jun. 21, 2023, which claims the benefit of Japanese Patent Application No. 2022-101379, filed Jun. 23, 2022, and Japanese Patent Application No. 2023-090082, filed May 31, 2023, all of which are hereby incorporated by reference herein in their entirety.

### BACKGROUND

### Field of the Disclosure

The present disclosure relates to an electroconductive film, a sensor device, and a method of producing an electroconductive film.

### Description of the Related Art

Fibroin has high biocompatibility and has mechanical strength, heat resistance, and the like, and is hence suitably used in, for example, a wearable sensor device that is attached to a living body to read biometric information, such as sweat and a pulse.

A sensor device used in a wearable manner may be, for example, a device having an electric circuit including an electrode on a film-like material. Such sensor device is used, for example, by being wrapped around the arm to read a biosignal from the skin through the electrode, thereby being capable of detecting biometric information. In order to use a sensor device in a wearable manner, the sensor device is produced by arranging an electrode or extraction wiring formed of an electroconductive material such as a metal on a film-like material having low skin sensitization and high biocompatibility to form an electric circuit. When an enzyme reaction detecting mechanism or a mechanism for reading a change in resistance value is arranged in an electrode portion, biometric information can be detected and extracted as an electric signal.

The above-mentioned sensor device is used by being worn in daily life. As a result, the sensor device is repeatedly subjected to abrasion, bending, and temperature changes. Thus, in a base material, it is effective to use fibroin as a resin having sufficient biocompatibility, mechanical strength, and heat resistance.

A formed body, such as a film, a sheet, a coating film, or a fiber, of fibroin may be obtained, for example, by dissolving silk fibroin, which is a protein produced by silkworm larvae in their bodies, in water or a solvent to form a silk fibroin solution, then spreading the solution on a substrate, and drying the solution.

In Japanese Patent Application Laid-Open No. 2020-94197, there is a description of a method of forming a fibroin solution containing a fluorine solvent into a film. In Japanese Patent Application Laid-Open No. 2020-94197, there is a description that there are an α-helix structure and a β-sheet structure as secondary structures of a silk fibroin formed body, and there is also a description of a method of controlling the ratio of the β-sheet structure of a formed body. In “Silk Chemistry and Material Development,” Yasushi Tamada, Chemistry and Education, Vol. 64, No. 9 (2016), the β-sheet structure is defined as “a protein secondary structure in which a hydrogen bond is formed between peptide bonds within or between molecules, resulting in an overall flat structure.” In “Thermoplastic moulding of regenerated silk,” Nature Materials, 2020, 19, 102, there is a description of a method of quantitatively determining the ratio of the β-sheet structure in the secondary structure of silk fibroin from an IR spectrum.

Photolithography or plating treatment has hitherto been used as a method of forming an electric circuit on a film of fibroin or the like. However, due to problems such as a high environmental burden and high cost, a printing method involving directly recording a wiring pattern formed of an electroconductive substance, such as a metal or metal nanoparticles, by ink jet printing or screen printing, which does not require etching treatment, has been used in recent years. However, there is a problem in that a printed electroconductive wiring pattern easily peels off, and there is a demand for a method of recording an electroconductive wiring pattern having high film fixability.

For example, in Japanese Patent Application Laid-Open No. 2011-110715, there is a description of a recording method involving applying fibroin to a metal thin film with a coater.

However, the related art does not satisfy both the conduction of an electroconductive wiring pattern and the fixability thereof to a fibroin film. Thus, an object of the present disclosure is to provide a fibroin film having an electroconductive wiring pattern with high fixability, a sensor device, and a biological sensor device.

### SUMMARY

The inventors have made extensive investigations in order to solve the above-mentioned problems. As a result, the inventors have found that, when electroconductive nanoparticles are arranged in a fibroin film and on the surface thereof, the electroconductive nanoparticles in the fibroin film and on the surface thereof interact with each other, and hence both high electroconductivity and high fixability can be satisfied. The present disclosure has been achieved by repeatedly making investigations based on such finding.

That is, according to one embodiment of the present disclosure, there is provided an electroconductive film including: a base material containing fibroin; and electroconductive wiring containing a plurality of electroconductive particles, wherein the electroconductive wiring includes: a permeation portion formed of the electroconductive particles contained in a permeation layer in which the electroconductive particles have permeated the base material; and a non-permeation portion formed of the electroconductive particles prevented from permeating the base material.

In addition, according to one embodiment of the present disclosure, there is provided a sensor device including: an electroconductive film; and an electrode arranged on the electroconductive film.

Further, according to one embodiment of the present disclosure, there is provided a method of producing an electroconductive film including: applying a fibroin aqueous solution into a film shape; drying the applied film to form a base material; and recording an aqueous dispersion of electroconductive particles on the base material.

Further features of the present disclosure will become apparent from the following description of exemplary embodiments with reference to the attached drawings.

### BRIEF DESCRIPTION OF THE DRAWINGS

FIG. 1A is a view for illustrating an example of electroconductive wiring.

FIG. 1B is a view for illustrating an example of electroconductive wiring.

FIG. 1C is a view for illustrating an example of electroconductive wiring.

FIG. 1D is a view for illustrating an example of electroconductive wiring.

FIG. 2A is a view for illustrating an example of a sectional configuration of an electroconductive film according to an embodiment of the present disclosure.

FIG. 2B is a view for illustrating an example of a sectional configuration of the electroconductive film according to this embodiment.

FIG. 2C is a view for illustrating an example of a sectional configuration of the electroconductive film according to this embodiment.

FIG. 2D is a view for illustrating an example of a sectional configuration of the electroconductive film according to this embodiment.

FIG. 2E is a view for illustrating an example of a sectional configuration of the electroconductive film according to this embodiment.

FIG. 2F is a view for illustrating an example of a sectional configuration of the electroconductive film according to this embodiment.

### DESCRIPTION OF THE EMBODIMENTS

Embodiments of the present disclosure are described below, but the present disclosure is not limited to the following embodiments.

According to one embodiment of the present disclosure, there is provided an electroconductive film including: a base material containing fibroin; and electroconductive wiring containing a plurality of electroconductive particles, wherein the electroconductive wiring includes: a permeation portion formed of the electroconductive particles contained in a permeation layer in which the electroconductive particles have permeated the base material; and a non-permeation portion formed of the electroconductive particles prevented from permeating the base material

### (Electroconductive Film and Electroconductive Wiring)

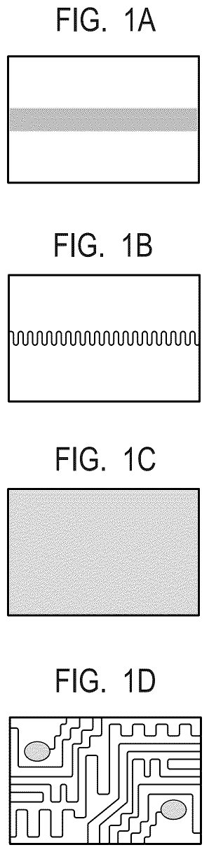

The electroconductive film of this embodiment has a thin film shape and has a thickness of preferably less than 250 μm. In this embodiment, the term “electroconductive wiring” refers to wiring that can provide electrical connection between a first point and a second point present on the electroconductive film. The first point and the second point are not particularly limited as long as the points are on the electroconductive film. For example, the first point and the second point may be present in a place in which an electronic component or an electrode is arranged, and may be in three-dimensional contact with the electronic component or the electrode. In addition, a plurality of combinations of the first point and the second point may be present on the electroconductive film, and these points may overlap each other. The electroconductive wiring may, for example, electrically connect a sensor electrode and an element to each other, and an element such as a resistor may be interposed therebetween. The electroconductive wiring may have a planar shape or a linear shape. The electroconductive wiring may be patterned so as to draw a circuit. In this embodiment, the electroconductive wiring is formed by incorporating a plurality of electroconductive particles that are present so sufficiently close to each other as to form electroconductive paths. However, the electroconductive wiring may contain electroconductive particles that do not contribute to current passage. Examples of the electroconductive wiring are illustrated in FIG. 1A to FIG. 1D. FIG. 1A is a view for illustrating an example in which the electroconductive wiring has a rectangular planar shape. FIG. 1B is a view for illustrating an example in which the electroconductive wiring has a wavy linear shape. FIG. 1C is a view for illustrating an example in which the electroconductive wiring is formed on the entire surface of an electroconductive film. FIG. 1D is a view for illustrating an example in which the electroconductive wiring forms a patterned circuit.

In addition, a space-saving electric circuit may be formed by laminating such electroconductive films as described above on the entire surface or partially to form electroconductive paths into a three-dimensional shape.

The thickness of the electroconductive wiring is preferably 50 nm or more. When the thickness is less than 50 nm, electroconductive paths between electroconductive particles are not sufficiently formed, and hence electroconductivity may not be exhibited. Further, the thickness of the electroconductive wiring is preferably 50 nm or more and 200 μm or less, more preferably 50 nm or more and 100 μm or less. When the thickness of the electroconductive wiring is set to 200 μm or less, the risk of the electroconductive wiring coming into contact with other objects on the electroconductive film can be reduced. The electrical conductivity of the electroconductive wiring is preferably 10³ Ω⁻¹·cm⁻¹ or more and 10⁶ Ω⁻¹·cm⁻¹ or less.

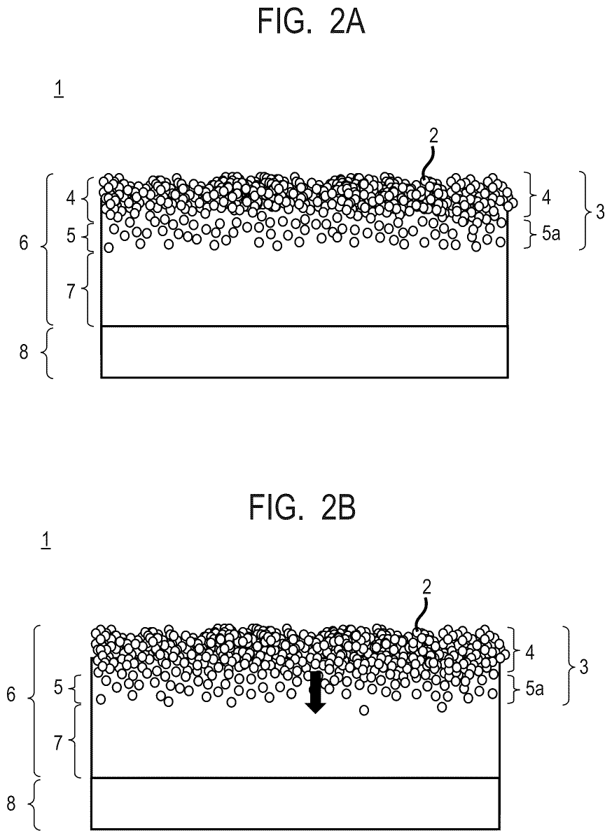

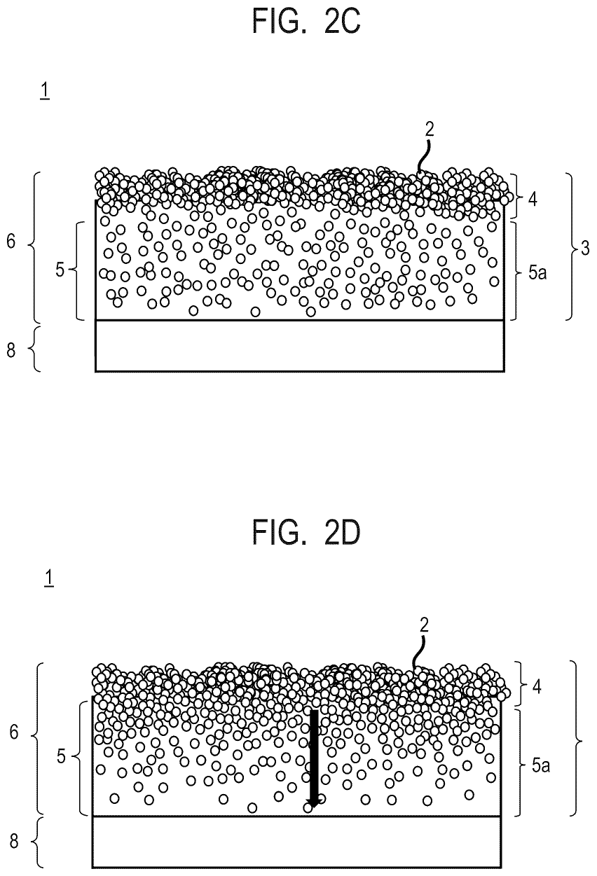

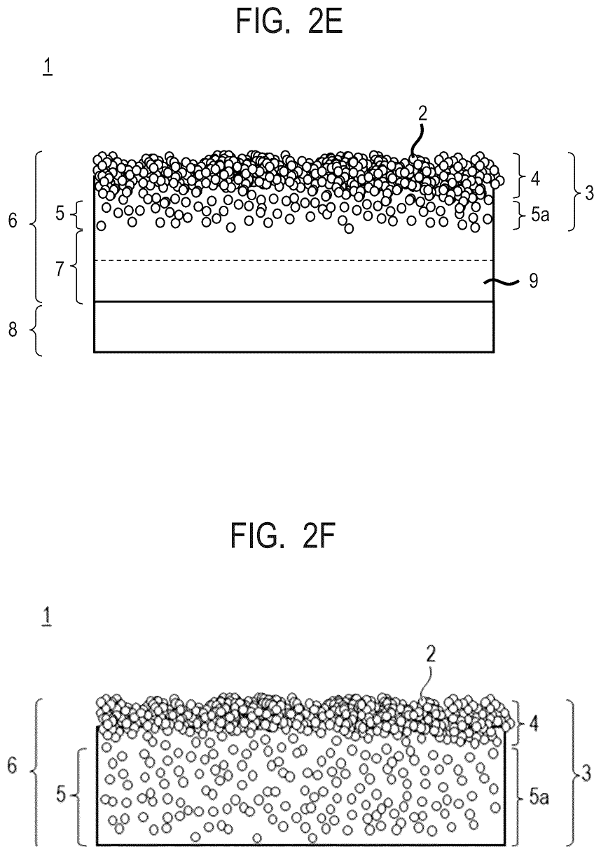

An example of a sectional configuration of an electroconductive film according to this embodiment is illustrated in FIG. 2A. An electroconductive film 1 includes a base material 6 containing fibroin (hereinafter sometimes referred to as “fibroin base material” or “base material”) and electroconductive wiring 3 containing a plurality of electroconductive particles 2. In addition, the electroconductive film 1 may include a foundation 8. However, the foundation 8 is not essential for the electroconductive film 1 of this embodiment. The electroconductive film 1 may have the surface coated. Further description is given below with reference to FIG. 2A to FIG. 2F.

### (Electroconductive Particles)

The electroconductive particles 2 are particles formed of a metal or a metal oxide, and are preferably formed of at least one kind of metal selected from the group consisting of: nickel; palladium; indium; tin; platinum; copper; silver; and gold as the kind of the metal. The metal may be an oxide thereof, and an element may be dissolved and doped in order to reduce resistance. Examples of the element to be doped may include antimony, indium, silicon, germanium, tin, phosphorus, magnesium, and aluminum.

The electroconductive particles 2 are desirably nanoparticles, and have a volume-based 50% cumulative particle diameter of preferably 5 nm or more and 100 nm or less, more preferably 10 nm or more and 50 nm or less from the viewpoint of permeability into the fibroin base material. When the electroconductive particles 2 having a volume-based 50% cumulative particle diameter of less than 5 nm are used, the particles are liable to be aggregated to become less likely to stably permeate the fibroin base material. In addition, it is not preferred that the electroconductive particles 2 having a volume-based 50% cumulative particle diameter of more than 100 nm be used because the particles are less likely to permeate the fibroin base material. The particle diameter of each of the electroconductive particles 2 may be measured by transmission electron microscopy, a small-angle X-ray scattering method, or the like.

### (Base Material Containing Fibroin and Fibroin)

The electroconductive film 1 of this embodiment includes the fibroin base material 6. Fibroin to be used as a raw material for the fibroin base material 6 is a protein molecule having, as a primary structure, such a region that a motif in which six amino acids (glycine-alanine-glycine-alanine-glycine-serine/tyrosine) are bonded to each other is repeated, and may be obtained by removing foreign substances from silk, raw silk produced by insects or spiders, or cocoons. Examples of the insects or the spiders include the varieties described in Japanese Patent Application Laid-Open No. 2018-150637. The higher-order structure of the fibroin may be classified into random coil, α-helix, and β-sheet structures, and the affinity between the fibroin base material and water may be controlled by the ratio of the β-sheet structure, which exhibits a water insoluble property, out of those structures. That is, the permeability of an aqueous dispersion of electroconductive particles such as a metal ink for ink jet may be controlled by adjusting the β-sheet ratio of the fibroin base material in a permeation layer 5. An increase in β-sheet ratio is advantageous from the viewpoint of fixability because electroconductive particles that have permeated the inside of the fibroin base material are easily fixed while hydrophobicity is increased to cause difficulty in permeation. Meanwhile, a reduction in β-sheet ratio is disadvantageous from the viewpoint of electroconductivity because the electroconductive particles 2 forming a non-permeation portion 4 may not remain while hydrophilicity is increased to facilitate permeation. Thus, it is conceived that there is a preferred range of the β-sheet ratio in the recording of the electroconductive particles 2. For the above-mentioned reasons, the β-sheet ratio of the fibroin base material 6 is preferably 5% or more and 55% or less, more preferably 15% or more and 50% or less. Alternatively, the β-sheet ratio in the fibroin base material 6 may not be uniform. In this case, the β-sheet ratio of the layer (permeation layer) that includes the electroconductive particles 2 in a permeation portion 5a of the fibroin base material 6 is preferably 5% or more and 55% or less, more preferably 15% or more and 50% or less. The β-sheet ratio may be quantified by FT-IR analysis using an ATR method. Specifically, the method described in “Thermoplastic moulding of regenerated silk,” Nature Materials, 2020, 19, 102 may be used.

### (Foundation)

The foundation 8 is not essential for the electroconductive film 1 of this embodiment. A material for the foundation 8 is not particularly limited, and a material having a low heat-resistant temperature may be used. For example, paper, glass, a resin sheet, a ceramic, or a metal is preferred. The resin sheet is not particularly limited, and examples thereof include resins, such as polyethylene terephthalate (PET), polyimide (PI), polyethylene glycol (PEG), polyhydroxybutyrate (PHB), polycyanoacrylate, polyanhydride, polyketone, poly(orthoester), poly-ε-caprolactone, polyacetal, a poly(α-hydroxy ester), polycarbonate, poly(iminocarbonate), polyphosphazene, a poly(β-hydroxy ester), polypeptide, gelatin, cellulose, chitosan, collagen, and fibroin. A sheet formed of a resin having biocompatibility, such as polyhydroxybutyrate (PHB), polycyanoacrylate, polyanhydride, polyketone, poly(orthoester), poly-ε-caprolactone, polyacetal, poly(α-hydroxy ester), polycarbonate, poly(iminocarbonate), polyphosphazene, poly(β-hydroxy ester), polypeptide, gelatin, cellulose, chitosan, collagen, or fibroin, out of those resins is preferred. Of the biocompatible resin sheets, a resin sheet formed of a natural polymer, such as gelatin, cellulose, chitosan, collagen, or fibroin, is preferred. A coating method is, for example, a method, such as spray coating, ink jet, dispenser nozzle coating, spin coating, slit coating, roll coating, dip coating, blade coating, wire bar coating, or screen printing.

### (Permeation Portion/Non-permeation Portion)

As illustrated in FIG. 2A, in the electroconductive film 1 of this embodiment, the electroconductive wiring 3 includes the permeation portion 5a formed of the electroconductive particles 2 in which the electroconductive particles 2 have permeated the fibroin base material 6, and the non-permeation portion 4 formed of the electroconductive particles 2 that have not permeated the fibroin base material 6.

In the permeation layer 5, the electroconductive particles 2 forming the permeation portion 5a are included in the fibroin base material 6. The term “inclusion” refers to a state in which the electroconductive particles 2 have entered a fibroin matrix of the fibroin base material 6. It is conceived that the included electroconductive particles 2 are trapped in the fibroin matrix, and are hence brought into a state of being resistant to abrasion and unlikely to peel off. There may be a state in which only part of the electroconductive particles 2 are included, that is, the electroconductive particles 2 may be present across both the permeation portion 5a and the non-permeation portion 4. It is conceived that the electroconductive particles 2 in the permeation portion 5a interact with or are fused with the electroconductive particles 2 in the non-permeation portion 4 to exhibit an anchor effect, to thereby improve the fixability of the electroconductive wiring 3 to the fibroin base material 6. That is, it is desired that the electroconductive particles 2 in the permeation portion 5a and the electroconductive particles 2 in the non-permeation portion 4 interact with or be fused with each other. Such configuration exhibits an anchor effect and further increases the number of electroconductive paths. Thus, such configuration is advantageous also from the viewpoint of electroconductivity.

In order to exhibit the above-mentioned effect, the thickness of the permeation layer 5 is desirably 50 nm or more. Although it is not required to set the upper limit of the thickness of the permeation layer 5, the thickness is preferably 250 μm or less, more preferably 100 μm or less, still more preferably 50 μm or less, particularly preferably 30 μm or less. That is, a preferred thickness of the permeation layer 5 is, for example, 50 nm or more and 250 μm or less.

In addition, the thickness of the non-permeation portion 4 is desirably 50 nm or more. When the thickness is set to 50 nm or more, electroconductive paths between the electroconductive particles are sufficiently formed, and hence sufficient electroconductivity can be obtained. When the thickness of the electroconductive wiring 3 is larger, a larger current is allowed to pass. However, when the thickness is too large, the electroconductive wiring 3 may be brought into contact with a portion in which conduction is not intended, such as a nearby electronic component, and hence the thickness of the non-permeation portion 4 falls preferably 20 μm or less, more preferably 100 μm or less.

The permeation portion 5a and the non-permeation portion 4 may be distinguished from each other, for example, by observing the cross-section of the electroconductive film 1 with an electron microscope. In the permeation layer 5, it is recognized from an electron micrograph image that the electroconductive particles 2 are each present in the form of a particle in the fibroin base material 6. More specifically, in the permeation layer 5, the ratio of an area occupied by the electroconductive particles 2 with respect to an area occupied by the fibroin base material 6 in the electron micrograph image is preferably 30% or more and 90% or less, more preferably 40% or more and 90% or less, still more preferably from 50% to 90%. When the ratio of the area occupied by the electroconductive particles 2 is 30% or more, the ratio exceeds a percolation threshold value, and electroconductive paths are formed. When the ratio is more than 90%, the strength of the film is reduced.

In a lower layer 7 that is a portion below the permeation layer 5 in the fibroin base material 6, the ratio of an area occupied by the electroconductive particles 2 with respect to an area occupied by the fibroin base material 6 in the electron micrograph image is preferably 0% or more and less than 30%. When the ratio of the area occupied by the electroconductive particles 2 is less than 30%, percolation does not occur, and electroconductive paths are not formed. That is, the lower layer 7 is substantially free of the electroconductive particles 2. Alternatively, even when the lower layer 7 contains the electroconductive particles 2, the lower layer 7 contains the particles to the extent that electroconductive paths with the electroconductive wiring 3 are not formed.

As illustrated in FIG. 2C, the permeation layer 5 may extend across the entire fibroin base material 6, and the lower layer 7 may not be present. In addition, the presence ratio of the electroconductive particles 2 may not be uniform throughout the permeation layer 5, and the presence ratio of the electroconductive particles 2 may be gradually reduced downward (in a direction indicated by the arrows in the figures) as illustrated in FIG. 2B and FIG. 2D.

Meanwhile, the electroconductive particles 2 in the lower layer 7 do not form electroconductive paths, and hence the lower layer 7 functions as an insulating layer to contribute to the prevention of unintended current passage and leakage of electricity at the time of the use of the electroconductive film 1 to enhance current passage efficiency. Accordingly, it is more preferred that, in the electroconductive film 1 of this embodiment, the lower layer 7 be present. Thus, it is preferred that the lower layer 7 have an electrical conductivity of 10⁻²² Ω⁻¹·cm⁻¹ or more and 10⁻⁸ Ω⁻¹·cm⁻¹ or less.

In addition, the fibroin base material may further include a second fibroin base material 9 as illustrated in FIG. 2E. The second fibroin base material 9 may be formed by a method different from that for the fibroin base material 6. Alternatively, the second fibroin base material 9 may be formed of a fibroin aqueous solution having different composition, and may have a different β-sheet ratio.

In addition, as illustrated in FIG. 2F, the permeation layer 5 may extend across the entire fibroin base material 6, and the lower layer 7 and the foundation 8 may not be present. In addition, the electroconductive particles 2 may form conduction paths from an upper surface to a lower surface. The fibroin base material having conduction in a vertical direction thus obtained may be laminated as illustrated in FIG. 2E to form a three-dimensional conduction pattern.

### (Sensor Device)

According to one embodiment of the present disclosure, there is provided a sensor device including: the electroconductive film described above; and an electrode arranged on the electroconductive film.

The sensor device of the present disclosure includes an electrode on an electroconductive film having electroconductive wiring. Various electrodes may each be used as the electrode. The electrode may be an ion electrode, and a detection ion may be a cation, such as a hydrogen ion, a sodium ion, a potassium ion, a lithium ion, an ammonium ion, a rubidium ion, a cesium ion, a silver ion, a tantalum ion, a copper ion, a gold ion, a calcium ion, a lead ion, a mercury ion, or a magnesium ion, or may be an anion, such as a fluoride ion, a chloride ion, a bromide ion, an iodide ion, a sulfide ion, a cyanide ion, a thiocyanate ion, a perchlorate ion, a nitrate ion, a tetrafluoroborate ion, or a sulfate ion. The electrode may be designed to convert a chemical reaction to an electric signal, and an example thereof may be an enzyme electrode.

Examples of the enzyme electrode include a glucose oxidase, a uricase, an alcohol oxidase, a cholesterol oxidase, a lactate oxidase, a horseradish peroxidase, an L-amino acid oxidase, a lactate dehydrogenase, a penicillinase, and a β-glucosidase.

The sensor device of this embodiment preferably detects biometric information and is used in contact with a living body. The electrode may be, for example, a surface electrode, and may detect a brain wave, a signal for an electrocardiogram, cutaneous electroreflection, or a signal for an electromyogram. Alternatively, the electrode may be a subcutaneous electrode, and may detect a muscle action potential or a nerve action potential. For example, the electrode may detect components contained in blood and metabolites, such as sweat and urine. The electrode may be attached to the skin, or may be in a form that is worn at all times.

### (Method of Producing Fibroin Film Having Electroconductive Wiring Pattern)

According to one embodiment of the present disclosure, there is provided a method of producing an electroconductive film including: applying a fibroin aqueous solution into a film shape; drying the applied film to form a base material; and recording an aqueous dispersion of electroconductive particles on the base material.

### (Fibroin Aqueous Solution)

A fibroin aqueous solution in the method of producing a fibroin film having an electroconductive wiring pattern of this embodiment contains fibroin and water. The concentration of the fibroin is not particularly limited, but when the concentration is 40 parts by weight or more with respect to the weight of the aqueous solution, fluidity may be impaired. The molecular weight of a fibroin molecule in the fibroin aqueous solution is not particularly limited, but a large molecular weight of, for example, 40,000 or more is advantageous from the viewpoint of mechanical strength when the fibroin aqueous solution is formed into a film. As the fibroin aqueous solution, a liquid produced by insects or spiders may be used, and for example, a liquid extracted from the body of a silkworm may be used. In addition, cocoons of insects or spiders, or raw silk or silk prepared from cocoons may be used. Specifically, a fibroin aqueous solution extracted through the steps of: refining silk, raw silk, or cocoons to remove sericin; dissolving the refined raw silk or cocoons in a lithium bromide or calcium chloride solution under high temperature; and removing lithium bromide or calcium chloride may be used, or a fibroin aqueous solution extracted by a known method may be used. The fibroin aqueous solution may contain a small amount of sericin or a salt and may contain a stabilizer. Examples of the stabilizer include urea, thiourea, guanidine hydrochloride, guanidium thiocyanate, arginine, arginine hydrochloride, choline, choline chloride, ammonia, tetramethylammonium chloride, 1-methylpyridinium chloride, tetraethylammonium chloride, tetrapropylammonium bromide, tetrabutylammonium chloride, triethylmethylammonium chloride, tetramethylammonium acetate, tetraethylammonium hydroxide, ornithine hydrochloride, glycinamide hydrochloride, glycine ethyl ester hydrochloride, allantoin, hydantoin, aspartic acid, and glutamic acid. In addition, the fibroin aqueous solution may contain a gelling agent for improving a β-sheet ratio after film formation. Examples of the gelling agent include a cationic surfactant, an anionic surfactant, and a betaine.

(Step of Applying Fibroin Aqueous Solution into Film Shape)

The method of producing a fibroin film having an electroconductive wiring pattern of this embodiment includes the step of applying a fibroin aqueous solution into a film shape. In the application step, various methods may be used, and a known application method may be used. For example, a known coating method may be used, and the method may be, for example, an ink jet method, a flexo method, a spin coating method, a dispenser nozzle coating method, a slit coating method, a roll coating method, a dip coating method, a blade coating method, a wire bar coating method, or a screen printing method.

### (Step of Drying Applied Film)

The method of producing a fibroin film having an electroconductive wiring pattern of this embodiment includes the step of drying the film obtained by applying the fibroin aqueous solution. A drying temperature is not particularly limited, but is preferably 30° C. or more and less than 150° C. When the film is dried under low temperature, the process takes time, and the structure of the fibroin is gradually changed, which may lead to a stable structure with a high β-sheet ratio. Meanwhile, when the film is dried under high temperature, the structure of the fibroin is rapidly changed, and the β-sheet ratio may be reduced. A drying time is not particularly limited as long as volatile components can be sufficiently removed. However, it is conceived that, when the time taken for the removal becomes longer, the β-sheet ratio is increased.

### (Aqueous Dispersion of Electroconductive Particles)

The electroconductive wiring may be formed by recording an aqueous dispersion of electroconductive particles on a fibroin base material. The aqueous dispersion of electroconductive particles may contain an aqueous medium in addition to the electroconductive particles.

The aqueous medium is water or a mixed medium containing water as a main solvent in combination with a protic or non-protic organic solvent. As the organic solvent, a solvent that is miscible with or dissolved in water in any ratio is preferably used, and a homogeneous mixed medium containing 50 mass % or more of water is preferably used. Deionized water or ultrapure water is preferably used as the water.

The protic organic solvent is an organic solvent having a hydrogen atom (acidic hydrogen atom) bonded to oxygen or nitrogen. In addition, the non-protic organic solvent is an organic solvent free of any acidic hydrogen atom. Examples of the organic solvent may include alcohols, alkylene glycols, polyalkylene glycols, glycol ethers, glycol ether esters, carboxylic acid amides, ketones, ketoalcohols, and cyclic ethers.

Examples of the aqueous medium that may be suitably used may include water, a water/ethanol mixed solvent, a water/ethylene glycol mixed solvent, and a water/N-methylpyrrolidone mixed solvent.

The content of the aqueous medium is preferably 10.0 mass % or more and 95.0 mass % or less, more preferably 50.0 mass % or more and 95.0 mass % or less with respect to the total mass of the dispersion. It is not preferred that the content be more than 95 mass % because the concentration of the electroconductive particles is insufficient and electroconductivity at the time of recording is low. In addition, it is not preferred that the content be less than 10 mass % because the electroconductive particles are aggregated to become unlikely to permeate the inside of the film.

### (Step of Recording Aqueous Dispersion of Electroconductive Particles)

The method of producing a fibroin film having an electroconductive wiring pattern of this embodiment includes the step of recording an aqueous dispersion of electroconductive particles.

Various methods may each be used as a method of recording the aqueous dispersion of the electroconductive particles. Examples thereof include an ink jet method, a flexo method, a spin coating method, a dispenser nozzle coating method, a slit coating method, a roll coating method, a dip coating method, a blade coating method, a wire bar coating method, and a screen printing method. Of those, an ink jet method is preferably used. For example, the ink jet method is a method of recording an image on a recording medium by ejecting electroconductive nanoink from a recording head of an ink jet system. A system of ejecting a composition is, for example, a system involving applying mechanical energy to the composition or a system involving applying thermal energy to the composition. Known steps may be used as the steps of the ink jet recording method.

### (Step of Adjusting β-Sheet Ratio)

The method of producing a fibroin film having an electroconductive wiring pattern of this embodiment may include the step of adjusting a β-sheet ratio. Various methods may each be used as the method of adjusting a β-sheet ratio, and the β-sheet ratio of the fibroin film may be adjusted, for example, by controlling the drying temperature and the drying time. The β-sheet ratio of the fibroin film may be adjusted by treating the fibroin aqueous solution before the application. Specifically, a method involving subjecting the aqueous solution to shearing, a method involving applying heat to the aqueous solution, a method involving leaving the aqueous solution for a long period of time, a method involving adding a chemical substance to the aqueous solution, or a method involving causing a current to flow through the aqueous solution may be used. The β-sheet ratio of the fibroin film may be adjusted by treating the film after the drying. Specifically, the film may be subjected to water vapor or an organic solvent, shearing or pressure, heat, or a current flow. In addition, the β-sheet ratio of the fibroin film may be adjusted by a known method.

(Step of fusing Electroconductive Particles)

The method of producing a fibroin film having an electroconductive wiring pattern of this embodiment may include the step of fusing electroconductive particles. Various methods may each be used as the step of fusing the electroconductive particles. For example, a simple method involving applying an aqueous dispersion of electroconductive particles to a fibroin base material and then drying the aqueous dispersion at room temperature or a temperature in the vicinity thereof, that is, a temperature of 20° C. or more and 50° C. or less may be used. The aqueous dispersion of electroconductive particles may contain water, but the water or the composition may be evaporated to leave only the electroconductive particles. The aqueous dispersion may be dried by heating at high temperature or by a method that changes the β-sheet ratio of fibroin. The aqueous dispersion may be heated at a temperature of, for example, 50° C. or more and 200° C. or less. A method involving directly heating the electroconductive particles to be included with a laser, an ultrasound wave, or the like may be used. The period of time of the step is not particularly limited, and a step that takes, for example, 10 seconds or half a year may be used.

### EXAMPLES

The present disclosure is described in more detail below by way of Examples and Comparative Examples. However, the present disclosure is by no means limited to Examples below, and various modifications are possible without departing from the gist of the present disclosure. In the description of the amounts of components, “part(s)” and “%” are by mass unless otherwise specified.

### <Analysis Method>

An analysis method used in Examples is as described below.

### (Measurement of β-Sheet Ratio)

A β-sheet ratio was measured by a FT-IR method using a diamond ATR method. A FT-IR spectrum of a film was measured. The spectrum in the range of from 1,580 cm⁻¹ to 1,720 cm⁻¹ were separated into the following four peaks: a β-sheet structure-derived peak 1 (peak center: 1,620 cm⁻¹); a random coil/α-helix structure-derived peak (peak center: 1,645 cm⁻¹ to 1,655 cm⁻¹); a β-turn structure-derived peak (peak center: 1,685 cm⁻¹); and a β-sheet structure-derived peak 2 (peak center: 1,698 cm⁻¹). The peaks were each fitted with a Gaussian function, and a β-sheet ratio was calculated from the area ratios of the β-sheet structure-derived peaks.

Spectrum one (manufactured by Perkin-Elmer) was used as an analysis device.

### Example 1

### (Refinement of Silk)

4.5 L of ultrapure water was heated and boiled in a 5 L glass beaker, and then 8.48 g of sodium carbonate (manufactured by Kishida Chemical Co., Ltd.) was added thereto to provide a 0.02 mol/L sodium carbonate solution. 10 g of a cocoon of a domesticated silkworm (manufactured by Tajima Shoji Co., Ltd.) cut into 1 cm cubes was added to the sodium carbonate solution, and the mixture was heated for 30 minutes to provide silk having sericin removed therefrom. The silk was washed with cold ultrapure water. Then, the silk was drained, and was dried in a draft chamber overnight to provide refined silk.

### (Preparation of Fibroin Aqueous Solution)

0.86 g of lithium bromide (manufactured by Kishida Chemical Co., Ltd.) was loaded into a measuring cylinder, and the volume was filled up to 10 mL with water. Thus, a 9.3 mol/L lithium bromide solution was obtained. 3.0 g of the refined silk was filled into a 100 mL glass beaker, and 14.8 mL of the 9.3 mol/L LiBr solution was added thereto so that the refined silk was completely immersed in the solution. The refined silk was then dissolved in the solution in an oven at 60° C. for 2 hours to provide a transparent aqueous solution.

### (Refinement of Fibroin Aqueous Solution)

19 mL of the resultant transparent aqueous solution was injected into a dialysis cassette (manufactured by Thermo Fisher Scientific Inc.) having a molecular weight cut-off of 3,500 and a volume of 30 mL with a syringe, and the dialysis cassette was immersed in 2 L of ultrapure water to perform dialysis. The water was changed once every 8 hours, the dialysis was performed for a total of 48 hours to remove low-molecular-weight foreign substances and lithium ions. The resultant aqueous solution was rotated with a centrifuge CR7N (manufactured by Yamato Scientific Co., Ltd.) at 11,000 rpm/4° C. for 20 minutes so that impurities were removed. Thus, a fibroin aqueous solution was obtained. A molecular weight measured with a microchip electrophoresis device Agilent 2100 Bioanalyzer Electrophoresis System (manufactured by Agilent Technologies) was 100 kDa. The measurement was performed under the following conditions.
Microchip, separation matrix, fluorescent dye, electrophoresis buffer, and molecular weight standard ladder: Agilent Protein 230 kit
Control sample: bovine serum albumin lyophilized powder, >96% (agarose gel electrophoresis) (manufactured by Sigma-Aldrich Co., LLC, molecular weight: 66.5 kDa)
Diluent for silk fibroin aqueous solution and control sample, and concentrations thereof: a silk fibroin aqueous solution and a control sample were diluted to from 1.0 mass/vol % to 1.5 mass/vol % and about 1.3 mass/vol %, respectively, with an 8 M urea aqueous solution.
Excitation wavelength: 630 nm
Detection wavelength: 680 nm

In the calculation of the molecular weight of silk fibroin, dedicated 2100 Expert software was used. The molecular weight of silk fibroin was calculated from a molecular weight calibration curve obtained from data on a molecular weight standard ladder measured together with the sample. The most intensely colored band was used as a band in electrophoresis to be used for the calculation of the molecular weight.

The resultant fibroin aqueous solution was dried in an oven at 60° C. for 2 hours, and its solid concentration was measured to be 5.0%.

### (Production of Fibroin Film)

The produced fibroin aqueous solution was applied onto a PET film (manufactured by PANAC CO., LTD.) with Bar Coater #50 (manufactured by AS ONE Corporation) to provide a wet film having a thickness of 100 μm. The wet film was dried in an oven at 37° C. for 1 hour to provide a fibroin film 1. The result obtained by measuring a β-sheet ratio with a FT-IR device is shown in Table 1.

(Recording of Aqueous Dispersion of Electroconductive Particles with Bar Coater)

Aqueous gold ink DryCureAu-J (particle diameter: 20 nm, manufactured by C-INK Co., Ltd.) was applied as an aqueous dispersion of electroconductive particles onto the produced fibroin film 1 with Bar Coater #1 (manufactured by AS ONE Corporation) to provide an electroconductive ink wet film having a thickness of 2 μm. The resultant recorded product was dried under an environment of a temperature of 23° C. and a relative humidity of 55% for 24 hours, and was cut out into a shape measuring 2 mm by 3 cm with a cutter to provide an electroconductive film 1 (shape: rectangle measuring 2 mm by 3 cm). The resultant electroconductive film was frozen in liquid nitrogen, and the cross-section thereof was cut out with a razor. The cross-section was observed with a transmission electron microscope SU-70 (manufactured by Hitachi High-Tech Corporation). The thickness of a non-permeation portion and the thickness of a permeation layer each measured from a sectional image are shown in Table 1.

### Example 2

An electroconductive film 2 having electroconductive wiring was obtained in accordance with the method described in Example 1 except that the fibroin film produced in Example 1 was pressed with a hot press device (manufactured by AS ONE Corporation) for 15 minutes under the conditions of a high pressure of 632 MPa and a high temperature of 140° C. The measurement result of a β-sheet ratio, and the thickness of a non-permeation portion and the thickness of a permeation layer each measured from a sectional image are shown in Table 1.

### Example 3

(Recording of Aqueous Dispersion of Electroconductive Particles with Ink Jet Device)

Aqueous gold ink DryCureAu-J (particle diameter: 20 nm, manufactured by C-INK Co., Ltd.) was used as an aqueous dispersion of electroconductive particles, and this aqueous dispersion was recorded on a fibroin film by an ink jet method. That is, an ink tank filled with the aqueous gold ink DryCureAu-J was mounted on a piezo-head type ink jet device LaboJet-500 (manufactured by MICROJET Corporation) that was an ink jet recording apparatus. The aqueous gold ink DryCureAu-J was printed at a pitch of 100 μm on the fibroin film produced in Example 1 with the recording apparatus to provide a metal ink recorded product (shape: rectangle measuring 2 mm by 3 cm). The resultant recorded product was dried under an environment of a temperature of 23° C. and a relative humidity of 55% for 24 hours to provide an electroconductive film 3 (shape: rectangle measuring 2 mm by 3 cm). The resultant electroconductive film was frozen in liquid nitrogen, and the cross-section thereof was cut out with a razor. The cross-section was observed with a transmission electron microscope SU-70 (manufactured by Hitachi High-Tech Corporation). The thickness of a non-permeation portion and the thickness of a permeation layer each measured from a sectional image are shown in Table 1.

### Example 4

An electroconductive film 4 was obtained in accordance with the method described in Example 3 except that the fibroin film produced in Example 1 was pressed with a hot press device (manufactured by AS ONE Corporation) for 15 minutes under the conditions of a high pressure of 632 MPa and a high temperature of 140° C. The measurement result of a β-sheet ratio, and the thickness of a non-permeation portion and the thickness of a permeation portion each measured from a sectional image are shown in Table 1.

### Example 5

An electroconductive film 5 was obtained in accordance with the method described in Example 3 except that the drying conditions of the wet film after the application of the fibroin aqueous solution were changed to drying in an oven at 60° C. for 1 hour. The measurement result of a β-sheet ratio, and the thickness of a non-permeation portion and the thickness of a permeation layer each measured from a sectional image are shown in Table 1.

### Example 6

An electroconductive film 6 was obtained in accordance with the method described in Example 3 except that the drying conditions of the wet film after the application of the fibroin aqueous solution were changed to drying in an oven at 37° C. for 4 hours. The measurement result of a β-sheet ratio, and the thickness of a non-permeation portion and the thickness of a permeation layer each measured from a sectional image are shown in Table 1.

### Example 7

An electroconductive film 7 was obtained in accordance with the method described in Example 3 except that the drying conditions of the wet film after the application of the fibroin aqueous solution were changed to drying in an oven at 40° C. for 7 hours. The measurement result of a β-sheet ratio, and the thickness of a non-permeation portion and the thickness of a permeation layer each measured from a sectional image are shown in Table 1.

### Example 8

An electroconductive film 8 was obtained in accordance with the method described in Example 3 except that the drying conditions of the wet film after the application of the fibroin aqueous solution were changed to drying in an oven at 80° C. for 7 hours. The measurement result of a β-sheet ratio, and the thickness of a non-permeation portion and the thickness of a permeation layer each measured from a sectional image are shown in Table 1.

### Example 9

An electroconductive film 9 was obtained in accordance with the method described in Example 6 except that the aqueous dispersion of electroconductive particles was changed to aqueous silver ink DryCureAg-J (particle diameter: 20 nm, manufactured by C-INK Co., Ltd.). The measurement result of a β-sheet ratio, and the thickness of a non-permeation portion and the thickness of a permeation layer each measured from a sectional image are shown in Table 1.

### Example 10

An electroconductive film 10 was obtained in accordance with the method described in Example 6 except that the aqueous dispersion of electroconductive particles was changed to aqueous gold colloid (particle diameter: 5 nm, manufactured by Merck KGaA) concentrated to 5% by centrifugation. The measurement result of a β-sheet ratio, and the thickness of a non-permeation portion and the thickness of a permeation layer each measured from a sectional image are shown in Table 1.

### Example 11

An electroconductive film 11 was obtained in accordance with the method described in Example 6 except that the aqueous dispersion of electroconductive particles was changed to aqueous gold colloid (particle diameter: 100 nm, manufactured by Merck KGaA) concentrated to 5% by centrifugation. The measurement result of a β-sheet ratio, and the thickness of a non-permeation portion and the thickness of a permeation layer each measured from a sectional image are shown in Table 1.

### Example 12

An electroconductive film 12 was obtained in accordance with the method described in Example 6 except that the method of recording an aqueous dispersion of electroconductive particles was changed to the method described in Example 1. The measurement result of a β-sheet ratio, and the thickness of a non-permeation portion and the thickness of a permeation layer each measured from the sectional image are shown in Table 1.

### Example 13

An electroconductive film 13 was obtained in accordance with the method described in Example 6 except that the wet film was dried in an oven at 37° C. for 4 hours and then exposed to ethanol vapor for 1 hour. The measurement result of a β-sheet ratio, and the thickness of a non-permeation portion and the thickness of a permeation layer each measured from a sectional image are shown in Table 1.

### Comparative Example 1

An electroconductive film 14 for comparison was obtained in accordance with the method described in Example 3 except that the drying conditions of the wet film after the application of the fibroin aqueous solution were changed to drying in a draft chamber at 25° C. for 7 hours. The measurement result of a β-sheet ratio, and the thickness of a non-permeation portion and the thickness of a permeation layer each measured from a sectional image are shown in Table 1.

### Comparative Example 2

An electroconductive film 15 for comparison was obtained in accordance with the method described in Example 3 except that the fibroin film obtained in accordance with the method described in Comparative Example 1 was pressed with a hot press device (manufactured by AS ONE Corporation) for 15 minutes under the conditions of a high pressure of 632 MPa and a high temperature of 180° C. The measurement result of a β-sheet ratio, and the thickness of a non-permeation portion and the thickness of a permeation layer each measured from a sectional image are shown in Table 1.

### Comparative Example 3

Solvent-based silver ink FlowMetal SR7040 (manufactured by Bando Chemical Industries, Ltd.) was recorded on the fibroin film obtained in accordance with the method described in Example 6 with Bar Coater #1 (manufactured by AS ONE Corporation) to form a wet metal film having a thickness of 4 μm. The resultant wet metal film was dried under an environment of a relative humidity of 55% for 24 hours to provide an electroconductive film 16 for comparison (shape: rectangle measuring 2 mm by 3 cm). The measurement result of a β-sheet ratio, and the thickness of a non-permeation portion and the thickness of a permeation layer each measured from a sectional image are shown in Table 1.

TABLE 1

| | Drying Conditions | | | |
|---|---|---|---|---|
| | Drying | Drying | | β-sheet |
| | temperature | time | β-sheet formation | ratio |
| Example No. | (° C.) | (h) | treatment after drying | (%) |
| Example 1 | 37 | 1 | — | 4.5 |
| Example 2 | 37 | 1 | Hot press treatment (140° C./15 min) | 56 |
| Example 3 | 37 | 1 | — | 4.5 |
| Example 4 | 37 | 1 | Hot press treatment (140° C./15 min) | 56 |
| Example 5 | 60 | 1 | — | 9.7 |
| Example 6 | 37 | 4 | — | 24.5 |
| Example 7 | 40 | 7 | — | 47.1 |
| Example 8 | 80 | 7 | — | 50.1 |
| Example 9 | 37 | 4 | — | 24.5 |
| Example 10 | 37 | 4 | — | 24.5 |
| Example 11 | 37 | 4 | — | 24.5 |
| Example 12 | 37 | 4 | — | 24.5 |
| Example 13 | 37 | 4 | Ethanol vapor treatment (1 h) | 35 |
| Comparative | 25 | 7 | — | 3 |
| Example 1 | | | — | |
| Comparative | 25 | 7 | Hot press treatment (180° C./15 min) | 63.2 |
| Example 2 | | | | |
| Comparative | 37 | 4 | — | 24.5 |
| Example 3 | | | | |

| | | | | | State of presence of | |
|---|---|---|---|---|---|---|
| | Aqueous dispersion of electroconductive particles | | | | electroconductive | |
| | | | | Water content of | particles | |
| | | | | aqueous | Thickness | Thickness |
| | | | | dispersion of | of non- | of |
| | Kind | Particle | | electroconductive | permeation | permeation |
| Example | of | Diameter | Recording | particles | portion | layer |
| No. | metal | (nm) | method | (%) | (nm) | (nm) |
| Example 1 | Au | 20 | Bar coating | 70 | 20 | 40 |
| Example 2 | Au | 20 | Bar coating | 70 | 40 | 20 |
| Example 3 | Au | 20 | IJ | 70 | 40 | 960 |
| Example 4 | Au | 20 | IJ | 70 | 940 | 60 |
| Example 5 | Au | 20 | IJ | 70 | 210 | 790 |
| Example 6 | Au | 20 | IJ | 70 | 420 | 580 |
| Example 7 | Au | 20 | IJ | 70 | 830 | 170 |
| Example 8 | Au | 20 | IJ | 70 | 920 | 80 |
| Example 9 | Ag | 20 | IJ | 70 | 420 | 580 |
| Example 10 | Au | 5 | IJ | 70 | 100 | 400 |
| Example 11 | Au | 100 | IJ | 70 | 1,400 | 100 |
| Example 12 | Au | 20 | Bar coating | 70 | 60 | 60 |
| Example 13 | Au | 20 | IJ | 70 | 600 | 400 |
| Comparative | Au | 20 | IJ | 70 | 0 | 1,000 |
| Example 1 | | | | | | |
| Comparative | Au | 20 | IJ | 70 | 1,000 | 0 |
| Example 2 | | | | | | |
| Comparative | Au | 20 | Bar coating | 0 | 100 | 0 |
| Example 3 | | | | | | |

### Example 14

The electroconductive film 1 produced in Example 1 was heated on a hot plate at 120° C. for 1 hour to provide the electroconductive film 1 after drying.

### (Evaluation of Electrical Conductivity)

The thickness of the resultant electroconductive image was measured with a stylus type thickness meter (manufactured by KLA-Tencor Corporation). The sectional area of an electroconductive image was calculated from the measured thickness, and a resistance was measured by a four-point probe method. Thus, electrical conductivity was calculated. The calculated electrical conductivity is shown in Table 2. In addition, the electrical conductivity of the electroconductive film 1 after drying was evaluated in accordance with the following evaluation criteria. In the following evaluation criteria, “A” represents an acceptable range and “B” represents an unacceptable range. The results are shown in Table 2.
A: The electrical conductivity was 5×10² S/cm or more.
B: The electrical conductivity was less than 5×10² S/cm or no electrical conductivity was exhibited.

### (Fixability Test and Evaluation)

A fixability test was performed by scratching the center of a printed film with a cutter so as to break up wiring, and electrical conductivity was measured and calculated in accordance with the electrical conductivity evaluation method. The measured and calculated electrical conductivity is shown in Table 2. In addition, the rate of reduction in electrical conductivity before and after the fixability test was calculated through use of the equation represented by Equation 1, and the fixability of the electroconductive film 1 after drying was evaluated in accordance with the following evaluation criteria. The results are shown in Table 2.

Rate (%) of reduction in electrical conductivity=−100×(1−electrical conductivity (S/cm) before fixability test/electrical conductivity (S/cm) after fixability test (Equation 1)
A: The rate of reduction in electrical conductivity was 50% or less.
B: The rate of reduction in electrical conductivity was more than 50% or no conductivity was exhibited after scratching.

### Example 15

The electroconductive film 2 produced in Example 2 was heated on a hot plate at 120° C. for 1 hour to provide the electroconductive film 2 after drying. In addition, the electroconductive film was subjected to the electrical conductivity measurement and evaluation, and the fixability test and evaluation, in accordance with the methods of Example 14. The results are shown in Table 2.

### Example 16

The electroconductive film 3 produced in Example 3 was heated on a hot plate at 120° C. for 1 hour to provide the electroconductive film 3 after drying. In addition, the electroconductive film was subjected to the electrical conductivity measurement and evaluation, and the fixability test and evaluation, in accordance with the methods of Example 14. The results are shown in Table 2.

### Example 17

The electroconductive film 4 produced in Example 4 was heated on a hot plate at 120° C. for 1 hour to provide the electroconductive film 4 after drying. In addition, the electroconductive film was subjected to the electrical conductivity measurement and evaluation, and the fixability test and evaluation, in accordance with the methods of Example 14. The results are shown in Table 2.

### Example 18

The electroconductive film 5 produced in Example 5 was heated on a hot plate at 120° C. for 1 hour to provide the electroconductive film 5 after drying. In addition, the electroconductive film was subjected to the electrical conductivity measurement and evaluation, and the fixability test and evaluation, in accordance with the methods of Example 14. The results are shown in Table 2.

### Example 19

The electroconductive film 6 produced in Example 6 was heated on a hot plate at 120° C. for 1 hour to provide the electroconductive film 6 after drying. In addition, the electroconductive film was subjected to the electrical conductivity measurement and evaluation, and the fixability test and evaluation, in accordance with the methods of Example 14. The results are shown in Table 2.

### Example 20

The electroconductive film 7 produced in Example 7 was heated on a hot plate at 120° C. for 1 hour to provide the electroconductive film 7 after drying. In addition, the electroconductive film was subjected to the electrical conductivity measurement and evaluation, and the fixability test and evaluation, in accordance with the methods of Example 14. The results are shown in Table 2.

### Example 21

The electroconductive film 8 produced in Example 8 was heated on a hot plate at 120° C. for 1 hour to provide the electroconductive film 8 after drying. In addition, the electroconductive film was subjected to the electrical conductivity measurement and evaluation, and the fixability test and evaluation, in accordance with the methods of Example 14. The results are shown in Table 2.

### Example 22

The electroconductive film 9 produced in Example 9 was heated on a hot plate at 120° C. for 1 hour to provide the electroconductive film 9 after drying. In addition, the electroconductive film was subjected to the electrical conductivity measurement and evaluation, and the fixability test and evaluation, in accordance with the methods of Example 14. The results are shown in Table 2.

### Example 23

The electroconductive film 10 produced in Example 10 was heated on a hot plate at 120° C. for 1 hour to provide the electroconductive film 10 after drying. In addition, the electroconductive film was subjected to the electrical conductivity measurement and evaluation, and the fixability test and evaluation, in accordance with the methods of Example 14. The results are shown in Table 2.

### Example 24

The electroconductive film 11 produced in Example 11 was heated on a hot plate at 120° C. for 1 hour to provide the electroconductive film 11 after drying. In addition, the electroconductive film was subjected to the electrical conductivity measurement and evaluation, and the fixability test and evaluation, in accordance with the methods of Example 14. The results are shown in Table 2.

### Example 25

The electroconductive film 12 produced in Example 12 was heated on a hot plate at 120° C. for 1 hour to provide the electroconductive film 12 after drying. In addition, the electroconductive film was subjected to the electrical conductivity measurement and evaluation, and the fixability test and evaluation, in accordance with the methods of Example 14. The results are shown in Table 2.

### Example 26

The electroconductive film 13 produced in Example 13 was heated on a hot plate at 120° C. for 1 hour to provide the electroconductive film 13 after drying. In addition, the electroconductive film was subjected to the electrical conductivity measurement and evaluation, and the fixability test and evaluation, in accordance with the methods of Example 14. The results are shown in Table 2.

### Comparative Example 4

The electroconductive film 14 for comparison produced in Comparative Example 1 was heated on a hot plate at 120° C. for 1 hour to provide the electroconductive film 14 for comparison after drying. In addition, the electroconductive film was subjected to the electrical conductivity measurement and evaluation, and the fixability test and evaluation, in accordance with the methods of Example 14. The results are shown in Table 2.

### Comparative Example 5

The electroconductive film 15 for comparison produced in Comparative Example 2 was heated on a hot plate at 120° C. for 1 hour to provide the electroconductive film 15 for comparison after drying. In addition, the electroconductive film was subjected to the electrical conductivity measurement and evaluation, and the fixability test and evaluation, in accordance with the methods of Example 14. The results are shown in Table 2.

### Comparative Example 6

The electroconductive film 16 for comparison produced in Comparative Example 3 was heated on a hot plate at 120° C. for 1 hour to provide the electroconductive film 16 for comparison after drying. In addition, the electroconductive film was subjected to the electrical conductivity measurement and evaluation, and the fixability test and evaluation, in accordance with the methods of Example 14. The results are shown in Table 2.

### Example 27

The electroconductive film 6 produced in Example 6 was dried in a draft chamber at 25° C. for 24 hours to provide the electroconductive film 6 after drying. In addition, the electroconductive film was subjected to the electrical conductivity measurement and evaluation, and the fixability test and evaluation, in accordance with the methods of Example 14. The results are shown in Table 2.

### Example 28

An electroconductive film 17 was produced by scraping off the bottom surface of the electroconductive film 6 after drying produced in Example 19 with sandpaper #1000. It was able to be recognized from the observation of a sectional image of the film that electroconductive particles were distributed up to the bottom surface. The conduction between the top surface side and the bottom surface of the film in a pattern formation portion was recognized, and it was recognized that electroconductive paths were three-dimensionally formed.

### Example 29

An electroconductive film 18 was produced by producing ten sheets of the electroconductive film 17 produced in Example 28, and laminating and pressure-bonding the sheets so that their pattern formation portions overlapped each other. The conduction between the top surface side and the bottom surface of the film in each of the pattern formation portions was recognized, and it was recognized that electroconductive paths were three-dimensionally formed.

TABLE 2

| | | | | | Electrical | Rate of | |
|---|---|---|---|---|---|---|---|
| | | | Electrical | | conductivity | reduction in | |
| | Electroconductive | Drying | conductivity | | after test | electrical | |
| | film after | temperature | (×10² | Electrocon | (×10² | conductivity | |
| Example No. | drying | (° C.) | S/cm) | ductivity | S/cm) | (%) | Fixability |
| Example 14 | 1 | 120 | 5 | A | 4 | 25 | A |
| Example 15 | 2 | 120 | 7 | A | 5 | 40 | A |
| Example 16 | 3 | 120 | 5 | A | 5 | 0 | A |
| Example 17 | 4 | 120 | 310 | A | 246 | 26 | A |
| Example 18 | 5 | 120 | 205 | A | 200 | 2 | A |
| Example 19 | 6 | 120 | 312 | A | 300 | 4 | A |
| Example 20 | 7 | 120 | 307 | A | 270 | 14 | A |
| Example 21 | 8 | 120 | 299 | A | 240 | 25 | A |
| Example 22 | 9 | 120 | 157 | A | 150 | 5 | A |
| Example 23 | 10 | 120 | 202 | A | 200 | 1 | A |
| Example 24 | 11 | 120 | 122 | A | 112 | 9 | A |
| Example 25 | 12 | 120 | 52 | A | 41 | 27 | A |
| Example 26 | 13 | 120 | 311 | A | 300 | 4 | A |
| Comparative | 14 | 120 | 0 | B | 0 | — | B |
| Example 4 | | | | | | | |
| Comparative | 15 | 120 | 280 | A | 0 | — | B |
| Example 5 | | | | | | | |
| Comparative | 16 | 120 | 292 | A | 0 | — | B |
| Example 6 | | | | | | | |
| Example 27 | 6 | 25 | 17 | A | 17 | 0 | A |

According to the present disclosure, an electroconductive film having electroconductive wiring with high fixability can be obtained, and an electroconductive film having electroconductive wiring with high fixability and a sensor device are provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An electroconductive film comprising:
a base material containing fibroin; and
electroconductive wiring containing a plurality of electroconductive particles,
wherein the electroconductive wiring includes:
a permeation portion formed of the electroconductive particles contained in a permeation layer in which the electroconductive particles have permeated the base material; and
a non-permeation portion formed of the electroconductive particles prevented from permeating the base material.

2. The electroconductive film according to claim 1, wherein the permeation layer has a thickness of 50 nm or more and 250 μm or less.

3. The electroconductive film according to claim 1, wherein the non-permeation portion has a thickness of 50 nm or more and 200 μm or less.

4. The electroconductive film according to claim 1, wherein the fibroin contained in the base material in the permeation layer has a β-sheet ratio of 5% or more and 55% or less.

5. The electroconductive film according to claim 1, wherein the fibroin in the base material in the permeation layer has a β-sheet ratio of 15% or more and 50% or less.

6. The electroconductive film according to claim 1, wherein the electroconductive particles are each formed of one of at least one kind of metal selected from the group consisting of: nickel; palladium; indium; antimony; tin; platinum; copper; silver; and gold or a metal oxide thereof.

7. The electroconductive film according to claim 1, wherein the electroconductive particles have a volume-based 50% cumulative particle diameter of 5 nm or more and 100 nm or less.

8. The electroconductive film according to claim 1 further comprising a foundation.

9. The electroconductive film according to claim 1, wherein the fibroin is derived from silk.

10. A sensor device comprising:
an electroconductive film including:
a base material containing fibroin; and
electroconductive wiring containing a plurality of electroconductive particles,
the electroconductive wiring including:
a permeation portion formed of the electroconductive particles contained in a permeation layer in which the electroconductive particles have permeated the base material; and
a non-permeation portion formed of the electroconductive particles prevented from permeating the base material; and
an electrode arranged on the electroconductive film.

11. The sensor device according to claim 10, wherein the electrode is used in contact with a living body.

12. A method of producing an electroconductive film comprising:
applying a fibroin aqueous solution into a film shape;
drying the applied film to form a base material; and
recording an aqueous dispersion of electroconductive particles on the base material.

13. The method of producing an electroconductive film according to claim 12, wherein fibroin in the fibroin aqueous solution has a β-sheet ratio of 5% or more and 55% or less.

14. The method of producing an electroconductive film according to claim 12, wherein fibroin in the fibroin aqueous solution has a β-sheet ratio of 15% or more and 50% or less.

15. The method of producing an electroconductive film according to claim 12, wherein a method of recording the aqueous dispersion of the electroconductive particles is an ink jet method.

16. The method of producing an electroconductive film according to claim 12 further comprising fusing the electroconductive particles after the recording the aqueous dispersion of the electroconductive particles.

17. The method of producing an electroconductive film according to claim 12, wherein fibroin in the fibroin aqueous solution is derived from silk.
